(19) United States
(12) Patent Application Publication
(10) Pub. No.: US 2026/0029343 A1
(43) Pub. Date: Jan. 29, 2026

(54) ULTRACOMPACT SPECTROMETERS FOR INFRARED WAVELENGTHS

(71) Applicants: Xi Wang, Newark, DE (US); Stephanie Law, University Park, PA (US); Sai Rahul Sitaram, Newark, DE (US); Shagorika Mukherjee, Newark, DE (US)

(72) Inventors: Xi Wang, Newark, DE (US); Stephanie Law, University Park, PA (US); Sai Rahul Sitaram, Newark, DE (US); Shagorika Mukherjee, Newark, DE (US)

(21) Appl. No.: 19/277,813

(22) Filed: Jul. 23, 2025

Related U.S. Application Data
(60) Provisional application No. 63/674,541, filed on Jul. 23, 2024.

(51) Int. Cl. G01N 21/552; G01J 3/02; G01J 3/12; G01N 21/25

(52) U.S. Cl. CPC G01N 21/553; G01J 3/0256; G01J 3/12; G01N 21/25; G01J 2003/1252; G01N 2021/258

(57) ABSTRACT

A surface plasmon resonance spectrometer includes a substrate, a first dielectric spacer, a detector, a second dielectric spacer, and a plurality of metal scattering structures. The substrate includes a region having a permittivity gradient. The first dielectric spacer is positioned on the substrate at a location corresponding to the region having the permittivity gradient. The detector is positioned over the region having the permittivity gradient with the first dielectric spacer therebetween. The second dielectric spacer is positioned on the detector opposite the first dielectric spacer. The plurality of metal scattering structures are positioned on the second dielectric spacer opposite the detector.

### CROSS-REFERENCE TO RELATED APPLICATIONS

This application claims priority to U.S. Patent Application No. 63/674,541, entitled “ULTRACOMPACT SPECTROMETERS FOR INFRARED WAVELENGTHS”, filed Jul. 23, 2024, the contents of which are incorporated herein by reference in their entirety.

### STATEMENT REGARDING FEDERALLY SPONSORED RESEARCH

This invention was made with government support under Grant No. 2102027 awarded by the National Science Foundation. The government has certain rights in the invention.

### TECHNICAL FIELD

The present invention relates generally to spectrometers, and more particularly, to ultracompact spectrometers utilizing metal-semiconductor plasmon resonance.

### BACKGROUND

A spectrometer is an apparatus for observing and analyzing a spectrum of light by dispersing light. Spectrometers may be used for understanding a structure and components of a material that emits or absorbs light. Conventional spectrometers include a prism spectrometer that uses a prism, a lattice spectrometer that uses a diffraction lattice, and an interference spectrometer that uses light interference.

### SUMMARY

Aspects of the present invention include spectrometers and methods for fabrication thereof.

In one aspect, a surface plasmon resonance spectrometer includes a substrate, a first dielectric spacer, a detector, a second dielectric spacer, and a plurality of metal scattering structures. The substrate includes a region having a permittivity gradient. The first dielectric spacer is positioned on the substrate at a location corresponding to the region having the permittivity gradient. The detector is positioned over the region having the permittivity gradient with the first dielectric spacer therebetween. The second dielectric spacer is positioned on the detector opposite the first dielectric spacer. The plurality of metal scattering structures are positioned on the second dielectric spacer opposite the detector.

In some aspects, the substrate can be a semiconductor material. The region of the substrate having the permittivity gradient can be a region having a dopant concentration gradient. In some aspects, the substrate can include a first region having a first dopant concentration, a second region having a second dopant concentration, and a third region having the permittivity gradient between the first region and the second region. The third region having the permittivity gradient can be a region having a dopant concentration gradient

In some aspects, the first and second dielectric spacers can be formed from a same dielectric material. In other aspects, they may be formed from different dielectric materials. The first and second dielectric spacers have thicknesses selected based on a desired degree of plasmon resonance between the metal scattering structures and the substrate, e.g., to increase, promote, or maximize such plasmon resonance.

In some aspects, the detector can include a plurality of graphene strips arranged directly on the first dielectric spacer. Ends of each of the plurality of graphene strips can be connected to electrical contacts. The contacts comprise a gold or silver thin film elements.

In some aspects, the metal scattering structures can be formed directly overlying the plurality of graphene strips. The metal scattering structures can be formed from gold.

In another aspect, a method of fabricating a surface plasmon resonance spectrometer includes producing a substrate comprising a region having a permittivity gradient using shadow mask molecular beam epitaxy, forming a first dielectric spacer on the substrate at a location corresponding to the region having the permittivity gradient, forming a detector on the first dielectric spacer positioned over the region having the permittivity gradient, forming a second dielectric spacer positioned on the detector opposite the first dielectric spacer, and depositing a plurality of metal scattering structures on the second dielectric spacer opposite the detector.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features may be arbitrarily expanded or reduced for clarity. Included in the drawings are the following figures:

FIG. 1A is a perspective view of an example spectrometer.

FIG. 1B is a cross-sectional diagram of the example spectrometer of FIG. 1A.

FIG. 2A is a diagram of an example system for fabricating elements of the example spectrometer of FIG. 1A.

FIG. 2B is a top view diagram of the example system of FIG. 2A.

FIG. 3 is a flow chart of an example method of fabricating a spectrometer.

### DETAILED DESCRIPTION

Infrared (IR) spectroscopy has attracted significant attention due to the multitude of applications in this spectral range, including thermal imaging, chemical sensing, environmental monitoring, medical imaging, security systems, atmospheric studies, and high-speed electronics. Of particular interest is the “fingerprint region” (6 μm-16 μm), where most molecules display fundamental vibrational absorption resonances and leave distinctive spectral fingerprints. These fingerprints can be used to identify unknown gases or monitor the concentration of known gases.

Portable and low-cost spectrometers for working at IR wavelengths are a key enabling technology. However, conventional IR spectroscopy systems are expensive, bulky, and require mechanical motion; their operation principle makes it impossible to significantly shrink their size. Existing on-chip configurations either require a large footprint and have low resolution or are limited to short working wavelengths (<2 μm).

The examples described herein utilize novel materials and fabrication processes to integrate gradient permittivity materials (GPMs) and near-field detector arrays on a chip. These items are particularly useful for fabrication ultracompact spectrometers (UCSs). Light incident on a UCS can be efficiently dispersed and mapped to reveal its spectral information. The disclosed UCS examples can collect spectral information at the nanoscale and significantly reduce the size and cost of a spectrometer.

The disclosed examples integrate wavelength demultiplexing elements and detector arrays on a chip, thereby eliminating complex optical elements and shrinking the dimensions of the design to the “fingerprint region” (6 μm-16 μm), and potentially as small as 10 μm or less, significantly smaller than other IR spectrometers. Examples of the novel materials and fabrication processes described herein include (1) fabricating graphene photodetector arrays to detect dispersed near-field signals; (2) utilizing metal-semiconductor plasmon resonance by fabricating conductive metal (e.g. gold) scatterers on top of a graphene photodetector array to enhance signal detection significantly; and (3) using shadow mask molecular beam epitaxy (MBE) technique to create GPMs, which significantly reduces the challenges of post-growth fabrications.

The disclosed examples achieve improvements over existing technology utilizing plasmon resonance in spectrometers, including that disclosed in U.S. Pat. No. 11,092,546, entitled “SPECTROMETER UTILIZING SURFACE PLASMON,” issued Aug. 17, 2021, the contents of which are incorporated herein by reference in their entirety. In particular, the disclosed examples enable improvements over pre-existing technology in at least the following ways. First, pre-existing technology is based on surface plasmon and surface plasmon resonance on GPMs themselves. By contrast, the examples described herein employ metal-semiconductor plasmon resonance between conductive metal (e.g. gold) scatterers and GPMs. Second, the disclosed examples achieve a much stronger signal enhancement effect than pre-existing technology. Third, GPMs disclosed herein can be fabricated according to a shadow mask MBE technique, which provides superior performance relative to previous known techniques.

The disclosed examples may be particularly well-suited for free space spectrometry with a wide acceptance angle. The dispersion of different wavelengths in the spectrometer singles relies on the material's properties, and is therefore independent of the angle of the spectrometer relative to the source. Moreover, the disclosed examples may not require any macroscopic optics or mechanical motion components. Dependent on size and materials, the disclosed examples may be useful over wavelength regions ranging from the mid-infrared to the terahertz range. Wavelength and spectral resolutions can depend on materials and on the preparation of the substrate with respect to its permittivity gradient.

Suitable uses and applications for the disclosed UCS examples will be understood from the description herein. For example, the disclosed UCS examples can strongly benefit portable and field-deployable devices, which are essential in size-limited systems for multiple applications, including toxic gas sensing, environmental monitoring, and/or volatile organic compound sensing. The disclosed examples can also provide low-cost spectrometers for hyperspectral imaging to benefit scientific research in agriculture, atmosphere, or space. The disclosed examples may be suitable for use in wearable devices to monitor thermal emission from objects, including the human body.

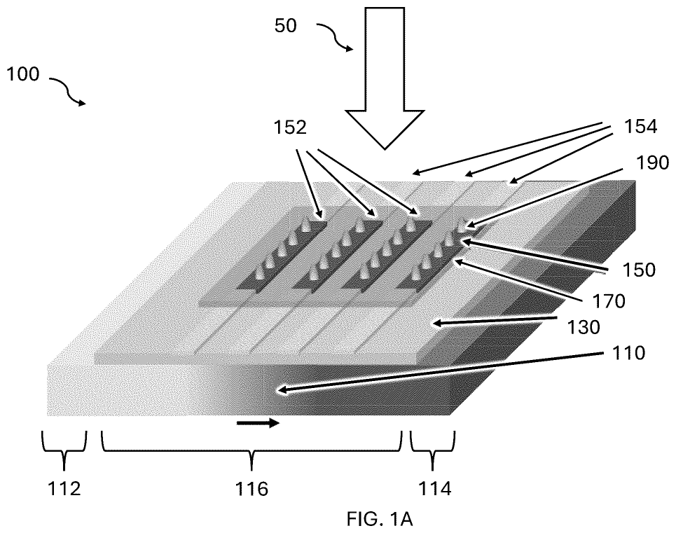

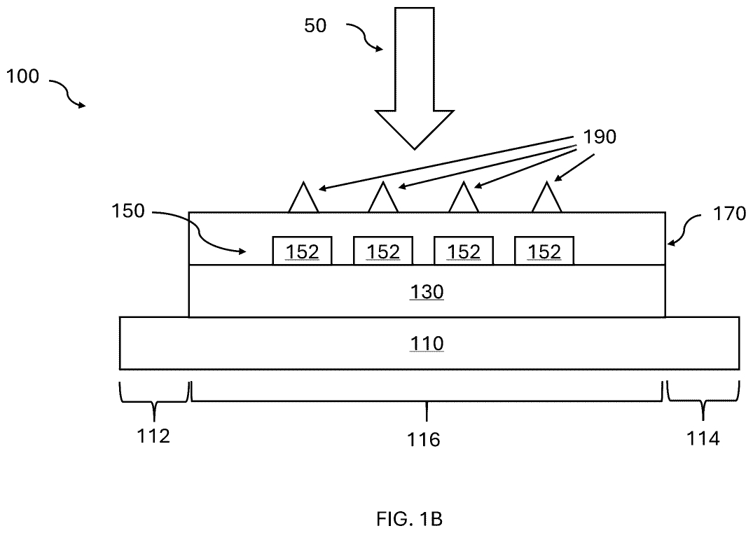

With reference to the drawings, FIGS. 1A and 1B depict an example spectrometer 100. Spectrometer 100 is a surface plasmon resonance spectrometer. As will be described in greater detail below, spectrometer 100 causes surface plasmon resonance to occur, resulting in the generation of increased light energy, which improves light detection and thus improves the quality or quantity of information that can be obtained from incident light 50. Spectrometer 100 may be configured for a particular wavelength band of incident light 50, e.g., from 5 μm to 30 μm. As a general overview, spectrometer 100 includes a substrate 110, dielectric spacers 130 and 170, a detector 150, and scattering structures 190. Additional details regarding spectrometer 100 are set forth below.

Substrate 110 provides support to elements of spectrometer 100. In some examples, substrate 110 may be formed from a semiconductor material. Suitable materials for use as substrate 110 include indium arsenide (InAs) or indium antimonide, and other suitable materials will be apparent from the description herein.

In some examples, substrate 110 can include a region having an in-plane (or horizontal) permittivity gradient. The permittivity gradient may be formed by doping a semiconductor material with elements that change the permittivity of the material dependent on dopant concentration. The semiconductor material can be doped with n-type or p-type dopants. As shown in FIGS. 1A and 1B, substrate 110 may include a first region 112 having a first dopant concentration and a first permittivity, and a second region 114 having a second dopant concentration and a second permittivity. The dopant concentration in the second region 114 may include a different concentration of the same dopant included in the first region 112, or may include a different dopant from the first region 112. Suitable dopants may dependent on the material of substrate 110. When substrate 110 is formed from a semiconductor material such as InAs, suitable dopants include silicon (Si), as the silicon-doped InAs provides suitable performance as a plasmonic material in the infrared regime. For other wavelengths, other semiconductor materials and dopants may be more suitable. Other suitable dopants will be apparent from the description herein.

As shown in FIGS. 1A and 1B, substrate 110 may further include a third region 116 between the first region 112 and the second region 114. In some examples, there may be a gap between regions 112, 114, and 116. In other examples, region 116 may directly extend from region 112 to region 114. In the example of FIGS. 1A and 1B, the third region includes the region of substrate 110 having the permittivity gradient. In other words, the third region may have a permittivity that transitions from the first permittivity of first region 112 to the second permittivity of second region 114. The permittivity gradient in the third region 116 may be created by forming a dopant concentration gradient in the region, such that the third region transitions from the first dopant concentration of first region 112 to the second dopant concentration of second region 114. The transitions described herein may be continuous, stepwise, periodic (e.g., with intermittent doped and undoped portions) or otherwise. In some examples, region 116 exhibits a linear change in concentration between first region 112 and second region 114. In other examples, region 116 may exhibit an exponential or logarithmic change in concentration.

Dielectric spacer 130 is formed on substrate 110. Spacer 130 is a layer of dielectric material that provides space between substrate 110 and other components of spectrometer 100. As shown in FIGS. 1A and 1B, dielectric spacer 130 is positioned on substrate 110 at a location corresponding to region 116 having the permittivity gradient. Dielectric spacer 130 may be formed through suitable vapor deposition processes, including for example atomic layer deposition. Suitable dielectric materials for use as dielectric spacer 130 include hexagonal boron nitride (hBN), due to its excellent electrical insulation properties and a large bandgap of ˜6 eV. Other suitable materials will be apparent from the description herein.

Detector 150 detects the light incident on spectrometer 100. As shown in FIGS. 1A and 1B, detector 150 is formed on dielectric spacer 130 over the region 116 having the permittivity gradient, such that dielectric spacer 130 is positioned between region 116 and detector 150. Detector 150 is configured to generate a signal in response to receiving light and/or an applied electric field.

In some examples, detector 150 comprises a plurality of nano-scale strips 152 formed on the surface of dielectric spacer 130. Strips 152 may be arranged parallel to one another directly on the upper surface of dielectric spacer 130, or may have different orientations. Suitable materials for use as strips 152 include, for example, graphene. Other suitable materials will be apparent from the description herein.

The ends of strips 152 may be connected to respective electrical contacts 154. As shown in FIGS. 1A and 1B, an electrical contact 154 is formed in contact with each end of each strip 152 of detector 150. Electrical contacts 154 may be connected to convey electrical signals from detector 150 to one or more processing elements in order to process signals received by spectrometer 100. In some examples, contacts 154 may be formed as thin film elements or traces on the upper surface of dielectric spacer 130. Suitable conductive materials for use in forming contacts 154 include, for example, gold or silver. Other suitable conductive materials will be apparent from the description herein.

In one example, detector 150 is formed as a graphene photodetector array. A graphene photodetector array may be particularly suitable to address the difficulty of converting from a near-field optical signal to an electrical signal. Due to its gapless band structure, graphene enables carrier generation by interband or intraband excitation with light over a very broad spectrum, ranging from the visible to the terahertz region. Graphene may further enable faster conversion of photons or plasmons into electrical currents, enabling spectrometer 100 to function at high speeds.

Dielectric spacer 170 is formed on detector 150. Spacer 170 is a layer of dielectric material position on detector 150 opposite dielectric spacer 130 such that detector 150 is sandwiched between dielectric spacers 130 and 170 at a location corresponding to region 116 having the permittivity gradient. In conjunction with spacer 130, dielectric spacer 170 may serve to enclose or encapsulate detector 150 within dielectric material. Dielectric spacer 170 may be formed from the same dielectric material as dielectric spacer 130, or may be formed from different dielectric material than dielectric spacer 170. Suitable dielectric materials for use as dielectric spacer 170 include those specified above with respect to dielectric spacer 130, and other suitable materials will be apparent from the description herein.

Scattering structures 190 are position on dielectric spacer 170. As shown in FIGS. 1A and 1B, structures 190 may be formed on the upper surface of dielectric spacer 170 opposite detector 150. In some examples, structures 190 are formed directly overlying the strips 152 of detector 150, such that the structures are formed in parallel linear arrays corresponding to and overlapping with the positioning of strips 152. Scattering structures may have any three-dimensional shape suitable for generating plasmon resonance with substrate 190, including for example discs, cylinders, domes, hemispheres, cones, pyramids, tetrahedra, cubes, rectangular prisms, etc. Other suitable shapes will be apparent from the description herein. Scattering structures 190 may have a diameter or width of 20 nm to 200 nm and may be formed to a height of 5 nm to 1200 nm. Scattering structures 190 may be formed from suitable metal materials including, for example, gold. Other suitable materials will be apparent from the description herein.

In the disclosed examples, metal-semiconductor plasmon resonance can occur between the metal scattering structures 190 and the region 116 of semiconductor substrate 110 having a permittivity gradient. This resonance may localize and enhance light fights, so that when monochromatic light illuminates spectrometer 100, the light field is localized at a specific location. The corresponding strip 152 may exhibit enhanced absorption, leading to generation of a larger photocurrent and improving electrical detection. For different incident wavelengths, enhanced absorption can occur within different nanostrips, allowing spectrometer 100 to measure spectral information.

The thickness of dielectric spacers 130 and 170 may be selected to promote, increase, or optimize the plasmon resonance between scattering structures 190 and substrate 110. The thickness of dielectric spacers 130 and 170 may, for example, be in a range of 3 nm to 30 nm. The thickness of spacers 130 and 170 may be varied through mechanical means, including for example mechanical exfoliation.

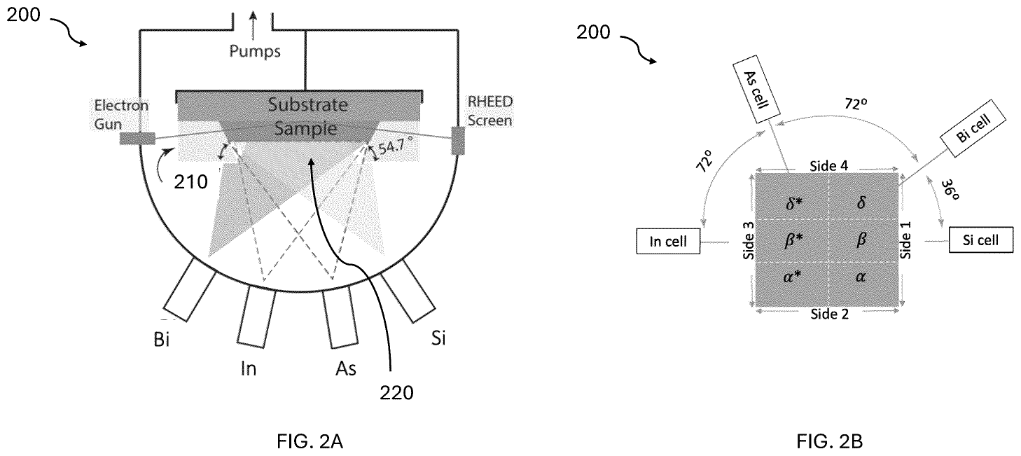

FIGS. 2A and 2B depict an example system 200 for fabricating a substrate of a spectrometer. The features of system 200 will generally be described below with respect to the elements of spectrometer 100. In some examples, system 200 performs shadow mask molecular beam epitaxy (SMMBE) in order to produce a suitable substrate 110 for spectrometer 100, e.g., a substrate 110 having a region 116 with a doping concentration gradient.

Shadow mask molecular beam epitaxy is a type of selective area epitaxy in which vacuum-deposited films can be patterned via a mechanical mask without the need for etching. As shown in FIG. 2A, mask 210 may be positioned adjacent to a substrate, and epitaxial layers may be sequentially deposited on the substrate through holes in the mask 210. One unique feature of SMMBE is its shadowing effect that appears near the mask edges, causing the elemental fluxes to vary as a function of position and orientation relative to the mask. This can give rise to a gradient of film thickness and/or composition near the edges of the mask. By varying the mask thickness and/or the angle of the mask edges, this gradient can be controlled. The result is formation of a material having a permittivity gradient, in which the material permittivity changes as a function of position in the plane of the substrate. In-plane permittivity gradients may be generated throughout the material, or on respective sides of the material. Likewise, different permittivity gradients may be generated on different sides (e.g. top and bottom) of the material dependent on the order and timing of deposition of elements during SMMBE. The permittivity gradient or gradients allow(s) confining varying wavelengths of light at varying horizontal locations of the substrate.

System 200 works by depositing material through mask 210 positioned adjacent the substrate sample. Mask 210 may be either directly fabricated on the substrate or placed in contact with the substrate. In some examples, mask 210 may have a sub-millimeter thickness, e.g., in the range of 200 μm to 500 μm. Thicker masks 210 may provide a longer shadow in comparison to thinner mask, leading to a larger gradient in permittivity over a longer in-plane distance in comparison to thinner masks providing less shadow. Mask 210 may be formed, for example, from silicon. Other suitable materials will be apparent from the description herein.

As shown in FIG. 2A, mask 210 may have an aperture 220 exposing a portion of the substrate to be doped. In some examples, aperture 220 may have a diameter dependent on a desired size of region 116, e.g., 0.3 cm to 0.7 cm, 0.4 cm to 0.6 cm, or about 0.5 cm. The walls of aperture 220 may be angled to promote the “shadow” effect of SMMBE along the edges of the aperture, and thereby create a doping gradient in the substrate. In some examples, the walls of aperture 220 may be provided at an angle, e.g., of 45°-65°, or about 55° (e.g. 54.7°, as shown in FIG. 2A).

During deposition, mask 210 remains in contact with the substrate, as shown in FIG. 2A. The deposition process relies on a non-zero angle between the dopant source and the normal surface of the substrate. This non-zero angle creates a “shadow” cast by edges of the mask to produce a gradient of film thickness and/or composition, giving rise to a region 116 of the substrate 110 having a permittivity gradient. As shown in FIG. 2A, flux gradients of both indium and silicon are created near the edges of the mask, enabling creation of a layer of Si-doped InAs material having a gradient in permittivity of the material in the in-plane direction of the material. Each location will thus have a different carrier density, leading to a different plasma frequency, and ultimately to a different permittivity. The substrate is not rotated, so that the gradient in doping concentration and permittivity is maintained throughout the deposition process and preserved in the final substrate. System 200 thus employs the shadow effect to create an in-plane (or horizontal) doping gradient in the resulting substrate 110, leading to the desired region 116 of varying permittivity.

As shown in FIG. 2B, system 200 may in some examples form a layer material that is substantially flat on one side but exhibits multiple, flat-topped, elevated regions (e.g., mesas). The material can be conceptually divided into six regions, as shown in FIG. 2B: regions α, β, and δ are near Side 1, closest to the silicon source; regions α*, β*, and δ* are near Side 3, closest to the indium source; regions α and α′ are closest to Side 2, while regions δ and δ* are closest to Side 4, near the bismuth and arsenic sources. The edges of the material may be thinner than the respective mesa regions, e.g., due in part to mask overhang casting a shadow relative to deposition sources.

FIG. 2B depicts cells of deposition material including an In cell, As cell, Bi cell, and Si cell. Suitable sources for use as deposition cells will be known from the description herein. It will further be understood that the type of element and orientation of these cells is provided for example purposes, and other elements and arrangements may be selected based on the desired material for substrate 110, as well as the desired wavelength region of operation of spectrometer 100. Likewise, the growth temperature during deposition may be controlled based on the desired properties of the substrate. Suitable growth temperatures include, for example, 450° C. to 500° C.

In manufacturing a proposed substrate 110 having a permittivity gradient using system 200, the gradient steepness can be selected by varying the mask design. For example, thick masks provide a greater shadowing effect, leading to a shallower gradient steepness and a longer in-plane permittivity gradient compared to thin masks. The in-plane spatial width of the material along which the permittivity gradient exists may be proportional to the mask thickness for some regions (e.g. on the elevated mesas), but may not depend solely on mask thickness in other regions (e.g., on the sloped edges of the material). It is also possible to tailor the in-plane permittivity gradient by keeping the mask design parameters constant but by varying the flux of the deposited elements, e.g., by varying the silicon flux or the indium flux.

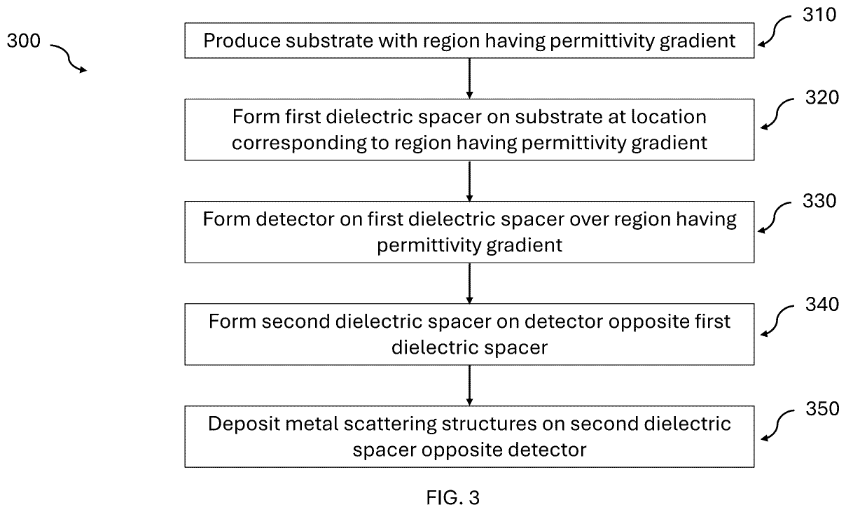

FIG. 3 depicts an example method 300 for fabricating a spectrometer. The steps of method 300 will generally be described below with respect to the elements of spectrometer 100. As a general overview, method 300 includes producing a substrate, forming dielectric spacers, forming a detector, and depositing scattering structures. Additional details regarding method 300 are set forth below.

In step 310, a substrate of the spectrometer is produced. In some examples, step 310 includes producing a substrate 110 having a region 116 having a permittivity gradient. Substrate 110 may be produced, in one example, using shadow mask molecular beam epitaxy. Other processes for producing substrate 110 will be apparent from the description herein.

In step 320, a first dielectric spacer is formed on the substrate. In some examples, step 320 includes forming dielectric spacer 130 on substrate 110 at a location corresponding to the region 116 having the permittivity gradient. Dielectric spacer 130 may be formed, for example, by chemical vapor deposition processes including atomic layer deposition. Other processes for forming dielectric spacer 130 will be apparent from the description herein.

In step 330, a detector is formed on the first dielectric spacer. In some examples, step 330 includes forming detector 150 on dielectric spacer 130 at a position directly above the region 116 having the permittivity gradient. Detector 150 may be formed, for example, by forming a thin film of detector material on the dielectric spacer, and patterning the thin film using a predetermined patterning process, for example, an e-beam lithography method. Other processes for forming detector 150 will be apparent from the description herein.

In step 340, a second dielectric spacer is formed on the substrate. In some examples, step 340 includes forming dielectric spacer 170 on detector 150 opposite dielectric spacer 130, at a location corresponding to the region 116 having the permittivity gradient. Dielectric spacer 170 may be formed by the same process or processes set forth above with respect to dielectric spacer 130. Other processes for forming dielectric spacer 170 will be apparent from the description herein.

In step 350, scattering structures are deposited on the second dielectric spacer. In some examples, step 350 includes depositing scattering structures 190 on dielectric spacer 170 opposite detector 150, at a location corresponding to the region 116 having the permittivity gradient. As noted herein, scattering structures 190 may be deposited such that they directly overlying the strips 152 of detector 150, such that the structures are formed in parallel linear arrays corresponding to and overlapping with the positioning of strips 152. Scattering structures 190 may be formed, for example, by known physical deposition processes. Other processes for forming scattering structures 190 will be apparent from the description herein.

Although aspects of the invention are illustrated and described herein with reference to specific examples, the invention is not intended to be limited to the details shown. Rather, various modifications may be made in the details within the scope and range of equivalents of the claims and without departing from the invention.

1. A surface plasmon resonance spectrometer comprising:
a substrate comprising a region having a permittivity gradient;
a first dielectric spacer positioned on the substrate at a location corresponding to the region having the permittivity gradient;
a detector positioned over the region having the permittivity gradient with the first dielectric spacer therebetween;
a second dielectric spacer positioned on the detector opposite the first dielectric spacer; and
a plurality of metal scattering structures positioned on the second dielectric spacer opposite the detector.

2. The spectrometer of claim 1, wherein the region having the permittivity gradient comprises a region having a dopant concentration gradient.

3. The spectrometer of claim 1, wherein the substrate comprises a semiconductor material.

4. The spectrometer of claim 1, wherein the detector comprises a plurality of graphene strips arranged directly on the first dielectric spacer.

5. The spectrometer of claim 4, wherein ends of each of the plurality of graphene strips are connected to electrical contacts.

6. The spectrometer of claim 5, wherein the contacts comprise a gold or silver thin film elements.

7. The spectrometer of claim 1, wherein the metal scattering structures are formed directly overlying the plurality of graphene strips.

8. The spectrometer of claim 1, wherein the first and second dielectric spacers are formed from a same dielectric material.

9. The spectrometer of claim 1, wherein the first dielectric spacer has a first thickness, the second dielectric spacer has a second thickness, and the first and second thicknesses are selected based on a desired degree of plasmon resonance between the metal scattering structures and the substrate.

10. The spectrometer of claim 1, wherein the plurality of metal scattering structures are formed from gold.

11. The spectrometer of claim 1, wherein the substrate comprises:
a first region having a first dopant concentration;
a second region having a second dopant concentration; and
a third region between the first region and the second region,
wherein the third region comprises the region having the permittivity gradient.

12. The spectrometer of claim 11, wherein the region having the permittivity gradient comprises a region having a dopant concentration gradient.

13. A method of fabricating a surface plasmon resonance spectrometer comprising:
producing a substrate comprising a region having a permittivity gradient using shadow mask molecular beam epitaxy;
forming a first dielectric spacer on the substrate at a location corresponding to the region having the permittivity gradient;
forming a detector on the first dielectric spacer positioned over the region having the permittivity gradient;
forming a second dielectric spacer positioned on the detector opposite the first dielectric spacer; and
depositing a plurality of metal scattering structures on the second dielectric spacer opposite the detector.
